(19) United States
(12) Patent Application Publication
(10) Pub. No.: US 2021/0026327 A1
(43) Pub. Date: Jan. 28, 2021

(54) INTELLIGENT PREDICTIVE ENGINE FOR MANAGEMENT AND OPTIMIZATION OF MACHINING PROCESSES FOR A COMPUTER NUMERICAL CONTROL (CNC) MACHINE TOOL

(71) Applicant: D.P. TECHNOLOGY CORP., Camarillo, CA (US)

(72) Inventor: Olivier Thenoz, Camarillo, CA (US)

(21) Appl. No.: 16/939,035

(22) Filed: Jul. 26, 2020

Related U.S. Application Data
(60) Provisional application No. 62/879,355, filed on Jul. 26, 2019.

(51) Int. Cl. G05B 19/414; G05B 19/4097; G05B 19/18; G06N 20/00; G06F 9/54

(52) U.S. Cl. CPC G05B 19/4145; G05B 19/4097; G06F 9/545; G06N 20/00; G05B 19/182

(57) ABSTRACT

Systems, devices, and methods for managing and optimizing a machining process for a computer numerical control (CNC) machine tool with a virtual machine-aware kernel. The virtual machine-aware kernel may predict steps for the manufacturing of a virtual machine part by constructing a virtual model of a CNC machine to mimic the CNC machine. The virtual machine-aware kernel may receive as input virtual data to simulate the real life conditions of the CNC machine milling processes for manufacturing of a machine part. The virtual machine-aware kernel may check, improve, and optimize the program data using the digital representation as a predictive model. Therefore, the virtual machine-aware kernel may allow for intelligent, real-time decision making to avoid defective manufacturing of a machine part.

### CROSS-REFERENCE TO RELATED APPLICATIONS

This application claims priority to and the benefit of U.S. Provisional Patent Application No. 62/879,355, filed Jul. 26, 2019, the contents of which are hereby incorporated by reference herein for all purposes.

### TECHNICAL FIELD

The invention in its several embodiments relates generally to management of machining processes, and more particularly to management and optimization of a machining process for a computer numerical control (CNC) machine tool with a virtual machine-aware kernel.

### BACKGROUND

Computer aided manufacturing (CAM) software systems are used to program computer numerical control (CNC) machine tools that are used in machine shops for the production of discrete parts, such as molds, dies, tools, prototypes, aerospace components and more.

CNC machine tools run a machining program that executes a series of instructions that are steps for the manufacturing of a part. CNC machine tools execute a machining program with no knowledge of the context. Execution of the program is sequential with a very short sight on the future and without a global overview of the processes.

### SUMMARY

A system for managing and optimizing a machining process for a computer numerical control (CNC) machine tool with a virtual machine-aware kernel is presented. Computer aided manufacturing (CAM) software systems are used to program CNC machine tools that are used in machine shops for the production of discrete parts such as molds, dies, tools, prototypes, aerospace components and more. The CAM software system may include a virtual machine-aware kernel that provides for changing and updating, in real time, a CNC machining program configured to determine a machining process for the CNC machine of the system.

In one embodiment, the system includes a computing device configured to execute processor-executable instructions for a virtual machine-aware kernel that is in communication with a machine, such as CNC machine.

The virtual machine-aware kernel may predict steps for the manufacturing of a virtual machine part by constructing a virtual model of a CNC machine to mimic the CNC machine, providing a 3-dimensional digital representation of the CNC machine. The virtual machine-aware kernel may receive as input virtual data to simulate the real life conditions of the CNC machine milling processes for manufacturing of a machine part. The virtual machine-aware kernel may check, improve, and optimize the program data using the digital representation as a predictive model. Therefore, the virtual machine-aware kernel may allow for intelligent, real-time decision making to avoid defective manufacturing of a machine part.

A system embodiment may comprise: a computer numerical control (CNC) machine having machining tools and configured to execute a series of instructions for machine operation; a computing device may be in communication with the CNC machine, where the computing device having a processor and an addressable memory, is configured to execute a virtual machine-aware kernel processor-executable set of instructions to: (1) determine, via a simulation engine, a virtually simulated real-world CNC machine and associated potential malfunctions based on received data from the CNC machine, the received data comprising program data, controller data, and sensor data; (2) determine, in real-time and while a machining program is being executed by the CNC machine, a modification to the machining program based on the determined virtually simulated real-world CNC machine and associated potential malfunctions, where the modification is based on determination of optimized program data that avoids the associated potential malfunctions; and transmit the determined optimized program data associated with the machine operation to the CNC machine, thereby the CNC machine continues with production and does not stop manufacturing process.

The system may further be where the computing device, via the virtual machine-aware kernel, may be further configured to modify the CNC machining program in real-time thereby predicting potential manufacturing issues and optimizing the data provided in the machining program by updating one or more subsequent steps in the machining program. Additionally, the determined optimized program data associated with the machine operation may provide precise milling operations by predicting future steps for accurate production of discrete machine parts.

In one embodiment, the program data may be a series of instructions to be executed sequentially, providing a machining program to the CNC machine. In another embodiment, the controller data may comprise CNC controller related data, comprising at least one of: tool offset information, work offset information, and machine controller configuration. In another embodiment, sensor data may be data associated with one or more sensors of the CNC machine and where the one or more sensors detect what is occurring during the machining process in real-time. Additionally, the one or more sensors of the CNC machine may be configured to monitor the machine tool by measuring at least one of: the cutting force, vibration amplitude, audible sound from the machining process, and high-frequency sound.

In one embodiment of the system configuration for intelligent predictive engine for management and optimization of machining processes for a CNC machine tool, modification to the machining program may be based on prediction of the potential malfunction, and determined using virtual data generated from the virtually simulated real-world CNC machine. In one embodiment, the potential malfunctions may be execution of CNC machining program that results in damage to the CNC machine, and may comprise at least one of: a tool colliding with a workpiece or with equipment holding the workpiece, damage to a tool due to too much engagement into material, resulting in tool breakage, violation of a target part due a tool cutting too much and gouging into a target part, slow execution where the machine cannot move fast enough because the instructions are not adapted to the machine kinematics, bad surface finish caused by vibrations due to bad cutting conditions or lack of rigidity. In another embodiment, the simulation engine of the virtual machine-aware kernel may be in communication with a motion optimizer engine, a planning engine, and a linking engine.

A method embodiment of the intelligent predictive engine for management and optimization of machining processes for a CNC machine tool, may comprise the steps of: determining, by a simulation engine of a virtual machine-aware kernel, a virtually simulated real-world CNC machine and associated potential malfunctions based on received data from the CNC machine, the received data comprising program data, controller data, and sensor data; determining, in real-time and while a machining program is being executed by the CNC machine, a modification to the machining program based on the determined virtually simulated real-world CNC machine and associated potential malfunctions, where the modification is based on determination of optimized program data that avoids the associated potential malfunctions; and transmitting the determined optimized program data associated with the machine operation to the CNC machine, thereby the CNC machine continues with production and does not stop manufacturing process.

The method may also include embodiments where the simulation engine of the virtual machine-aware kernel may be in communication with a motion optimizer engine, a planning engine, and a linking engine. In one embodiment, the motion optimizer of the virtual machine-aware kernel may be configured to modify tool motion, thus preventing overloading a machine tool and smoothing the tool motion on the physical axes. In another embodiment, the motion optimizer of the virtual machine-aware kernel may be configured to calculate optimized motion via modifying machine tool motion, thus preventing overloading a machine tool and smoothing the tool motion on the physical axes. In yet another embodiment, the motion optimizer of the virtual machine-aware kernel may be configured to verify that the calculated optimized motion is correct by running the calculated optimized motion through the virtually simulated real-world CNC machine. Additionally, the planning engine of the virtual machine-aware kernel may be configured to determine an optimized ordering by modifying the order of the machining processes based on the received sensor data, where the modification may be based on at least one of: minimizing occurrences of changing cutting tools, minimizing number of axis rotations, minimizing total angle of rotation per axis, and minimizing distance of travel of cutting tools.

Embodiments of the method may also include a scenario where the planning engine of the virtual machine-aware kernel may be configured to communicate the determined optimized ordering to the simulation engine for verification and evaluation of cycle times; and the planning engine of the virtual machine-aware kernel may further be configured to communicate the determined optimized ordering to the linking engine for verification and evaluation of cycle times. Additionally, the linking engine of the virtual machine-aware kernel may be configured to connect machining processes with a trajectory adapted to machine kinematics and capabilities associated with the CNC machine, and determine new motions after reordering the machining processes; the linking engine may be further configured to, based on the received data from the planning engine, communicate the determined new motions comprising optimized path, to the simulation engine.

The method embodiment may further be where the simulation engine may be configured to, continuously and in real-time, update the program data received initially from a program data interpreter to optimize the machine processes while the CNC machine is performing associated functions.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a system for managing and optimizing of a machining process for a computer numerical control (CNC) machine tool with a virtual machine-aware kernel;

FIG. 2 depicts a top-level functional block diagram of a computing device of the system of FIG. 1;

FIG. 3 depicts an alternative system for managing and optimizing of a machining process for a CNC machine tool with a virtual machine-aware kernel;

FIG. 4 depicts an alternative system for managing and optimizing of a machining process for a CNC machine tool with a virtual machine-aware kernel;

FIG. 5 depicts, in a functional block diagram, a virtual machine-aware kernel;

FIG. 6 depicts, in a top-level flow diagram, the virtual machine-aware kernel of FIG. 3 operating on a CNC machine;

FIG. 7 depicts, in a top-level flow diagram, managing and optimizing of a machining process for a CNC machine tool with the virtual machine-aware kernel of FIG. 3;

FIG. 8 depicts a flow chart for managing and optimizing of a machining process for a CNC machine tool with the virtual machine-aware kernel of FIG. 3;

FIG. 9 depicts a method of managing and optimizing of a machining process for a CNC machine tool;

FIG. 10 depicts a functional block diagram of the management and optimization by the virtual machine-aware kernel, for a CNC machine tool;

FIG. 11 shows a high-level block diagram and process of a computing system for implementing an embodiment of the system and process;

FIG. 12 shows a block diagram and process of an exemplary system in which an embodiment may be implemented; and

FIG. 13 depicts a cloud computing environment for implementing an embodiment of the system and process disclosed herein.

### DETAILED DESCRIPTION

The described technology concerns one or more methods, systems, apparatuses, and mediums storing processor-executable process steps for managing and optimizing a machining process for a computer numerical control (CNC) machine tool with a virtual machine-aware kernel.

The techniques introduced below may be implemented by programmable circuitry programmed or configured by software and/or firmware, or entirely by special-purpose circuitry, or in a combination of such forms. Such special-purpose circuitry (if any) may be in the form of, for example, one or more application-specific integrated circuits (ASICs), programmable logic devices (PLDs), field-programmable gate arrays (FPGAs), etc.

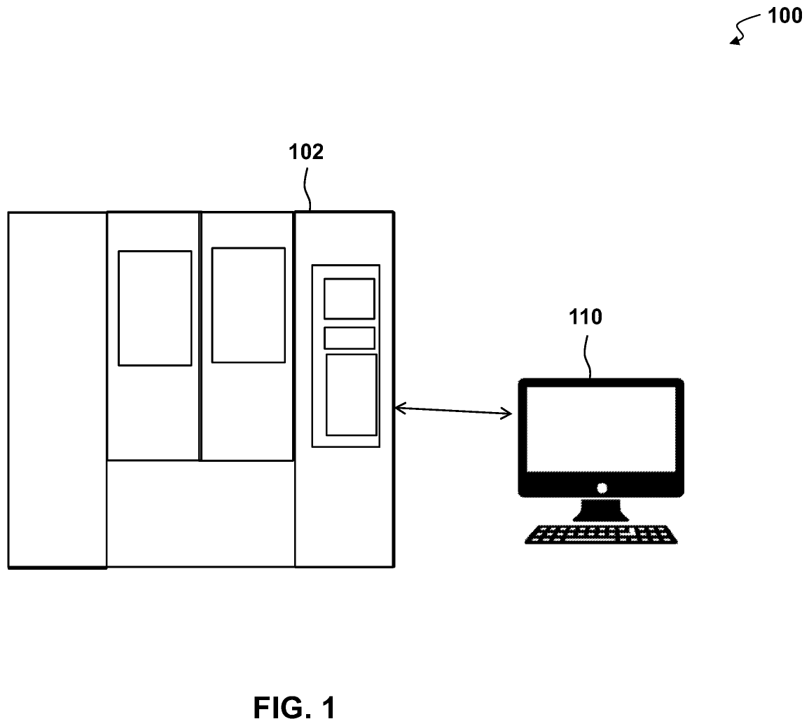

FIGS. 1-12 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

With respect to FIG. 1, a system 100 for managing and optimizing a machining process for a computer numerical control (CNC) machine tool with a virtual machine-aware kernel is illustrated. Computer aided manufacturing (CAM) software systems are used to program CNC machine tools that are used in machine shops for the production of discrete parts such as molds, dies, tools, prototypes, aerospace components, and more. The CAM software system may include a virtual machine-aware kernel that provides for changing and updating, in real time, a CNC machining program configured to determine a machining process for the CNC machine of the system 100.

In one embodiment, the system 100 includes a computing device 110 that is in communication with a machine, such as CNC machine 102. Generally speaking, the CNC machine 102 may run a machining program that executes a series of instructions, such as steps for the manufacturing of a machine part. The CNC machine 102 may execute the machining program with no knowledge of the context. Furthermore, the execution of the program may be sequential with a very short sight on the future and without a global overview of the processes.

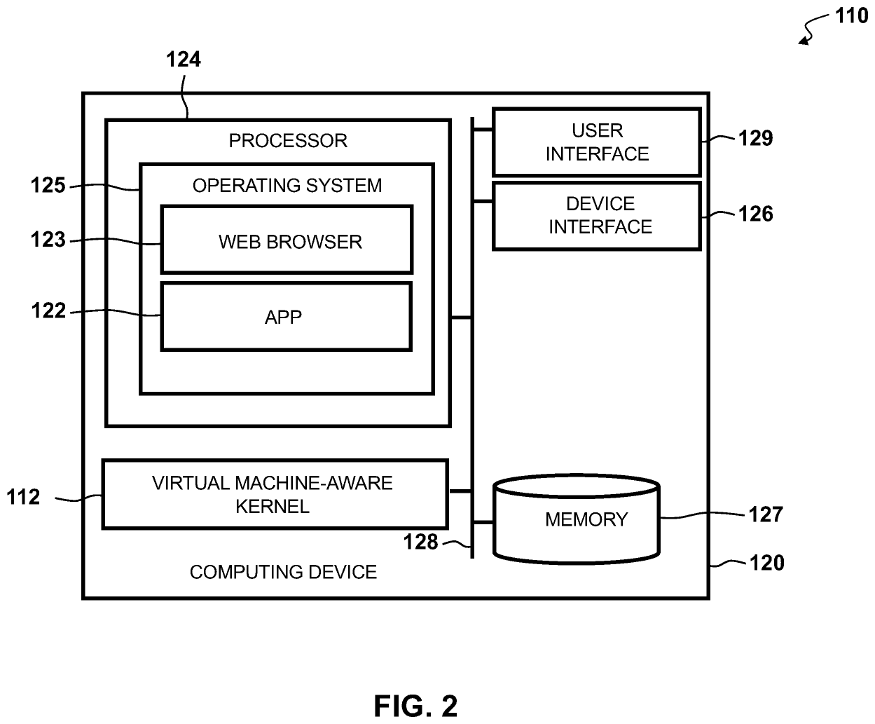

FIG. 2 illustrates an example embodiment of the virtual machine-aware kernel integrated into a computing device. Other embodiments, such as the virtual machine-aware kernel implemented in the cloud is also further described. With further reference to FIG. 2, a top level functional block diagram of the computing device 110 is illustrates, where the computing device 110 may comprise: a processor 124, such as a central processing unit (CPU), addressable memory 127, such as a lookup table, e.g., an array, an external device interface 126, e.g., an optional universal serial bus port and related processing, and/or an Ethernet port and related processing, an output device interface 123, and an optional user interface 129, e.g., an array of status lights, and one or more toggle switches, and/or a display, and/or a keyboard, and/or a pointer-mouse system, and/or a touch screen. Optionally, the addressable memory may, for example, be: flash memory, SSD, EPROM, and/or a disk drive and/or another storage medium. These elements may be in communication with one another via a data bus 128. An operating system 125, such as one supporting an optional web browser and applications, may be configured to, via the processor 124, execute steps of a machining program configured to determine a machining process for the CNC machine 102 of the system 100.

Generally speaking, a kernel is the core computer program of the computing operating system 125. The kernel may handle input/output requests from software, translating them into data-processing instructions for the processor 124. Furthermore, the kernel may be responsible for assigning and un-assigning memory space which allows software to run.

In one embodiment, the CAM software system includes a kernel that is a virtual machine-aware kernel 112. More specifically, the virtual machine-aware kernel 112 is the engine that provides for changing and updating, in real time or near real-time, a CNC machining program configured to determine a machining process for the CNC machine 102 of the system 100. The program may be based on digital representations of the CNC machine 102 and of the CNC machine's 102 equipment and environment, such as by way of 3-dimensional digital representations.

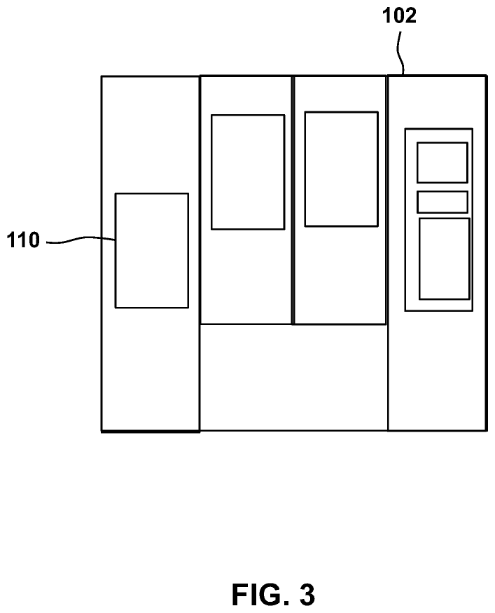

In one embodiment, the computing device 110 may be integrated directly into the CNC machine 102, as shown in FIG. 3. As will be discussed in more detail below, when the computing device 110, and hence the virtual machine-aware kernel 112, are integrated on the CNC machine 102, the virtual machine-aware kernel 112 may make adjustments to the machining operations as they are being executed by the CNC machine in real-time. That is, the virtual machine-aware kernel 112 may dynamically make changes to the program data for machining operations, e.g., machining program, as necessary, while the machining operations/program data is being executed and the CNC machine is performing machining operations and/or engaged with the workpiece via the machining tools.

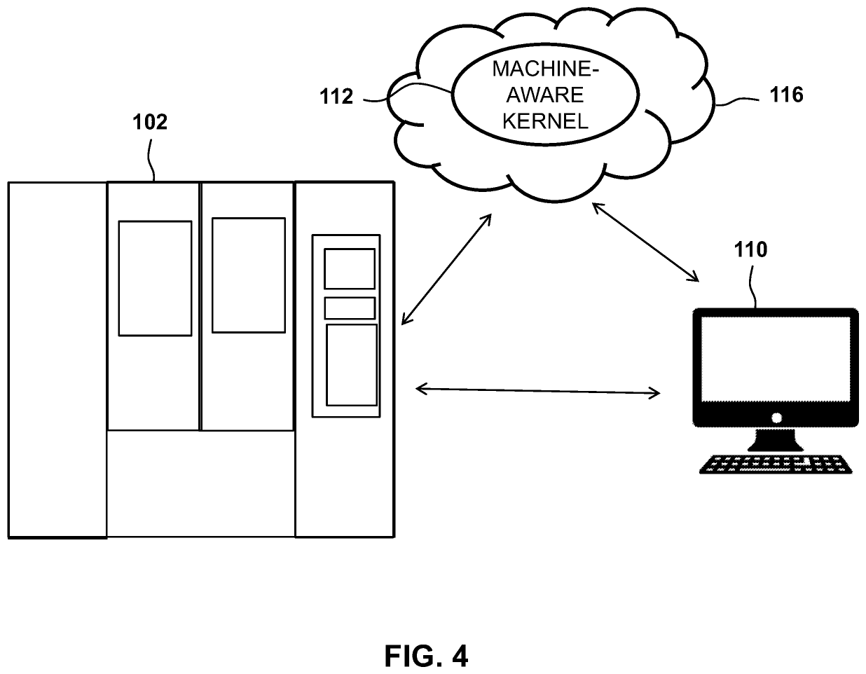

In another embodiment, and with reference to FIG. 4, the virtual machine-aware kernel 112 may operate in a cloud computing environment 116. In such embodiments, the cloud computing environment 116 comprises one or more cloud computing nodes with which local computing devices used by cloud consumers, such as, for example, personal digital assistant (PDA), smartphone, smart watch, set-top box, video game system, tablet, mobile computing device, or cellular telephone, desktop computer, laptop computer, and/or automobile computer system may communicate. The nodes may communicate with one another, for example, using Internet protocol communication layers such as transport layer, internet layer, and/or link layer. They may be grouped (not shown) physically or virtually, in one or more networks, such as Private, Community, Public, or Hybrid clouds as described hereinabove, or a combination thereof.

In one embodiment, the computing device 110 communicates with the virtual machine-aware kernel 112 that is stored in the cloud 116 to execute the steps of the virtual machine-aware kernel 112 for determining a machining process for the CNC machine 102. Therefore, the virtual machine-aware kernel 112 may be available through, for example, the internet as a cloud computing service.

In one embodiment, the virtual machine-aware kernel 112 may predict steps for the manufacturing of a virtual machine part. More specifically, a virtual model of a CNC machine may be constructed to mimic the CNC machine 102, providing a 3-dimensional digital representation of the CNC machine 102. The 3-dimensional digital model may represent the CNC machine 102 exactly, including all of the CNC machine's equipment and configurations—where, for example, all features and capabilities are depicted as accurately as possible. The virtual machine-aware kernel 112 may receive as input virtual (i.e., theoretical) data to simulate the real life conditions of the CNC machine 102 milling processes for manufacturing of a machine part. The virtual machine-aware kernel 112 may check, improve, and optimize the program data using the digital representation as a predictive model. Therefore, the virtual machine-aware kernel 112 may allow for intelligent, real-time decision making to avoid defective manufacturing of a machine part. That is, the CNC machine 102 using the virtual machine-aware kernel 112 may determine machining controls, for example, a tool speed, a tool feed, and a tool acceleration based on determined pivot, velocity, acceleration, and jerk, thereby avoiding any manufacturing defects during the milling process.

The virtual machine-aware kernel 112 may simulate real-world CNC machine malfunctions using the virtual data. This is advantageous because the execution of the CNC machining program may result in damage to the machine if there is no recourse for intelligently modifying the CNC machining program in real time. In one embodiment, the virtual machine-aware kernel 112 may not only predict, for example, a collision or some other malfunction of the machine, but may provide a new path that avoids the collision so the CNC machine 102 does not need to stop the manufacturing process. Configured as such, the virtual machine-aware kernel 112 may dynamically change the tool path, and provide a new trajectory before the initial trajectory commences. Furthermore, the virtual machine-aware kernel 112 may be configured to continually learn as more theoretical data is received, yielding a greater capability to make intelligent decisions, thereby both predicting potential manufacturing issues and optimizing the data provided in the machining program.

Simulating real-world CNC machine malfunctions using virtual data with the virtual machine-aware kernel 112 allows the virtual machine-aware kernel 112 to learn and predict steps to prevent malfunctioning of the CNC machine 102. For example, virtual modeling may present simulation scenarios where the execution of the CNC machining program may result in (1) a tool colliding with a workpiece or with the equipment holding the workpiece; (2) damage to the tool (for example: too much engagement into the material resulting in tool breakage); (3) violation of the target part (for example: a tool cuts too much and gouges into a target part); (4) slow execution (for example: the machine cannot move fast enough because the instructions are not adapted to the machine kinematics); and (5) bad surface finish (for example: vibrations due to bad cutting conditions or lack of rigidity). The virtual machine-aware kernel 112 may make adjustments in real time and dynamically make changes as necessary to prevent these sorts of malfunctions while the program is still being executed to allow the CNC machine 102 to continue production.

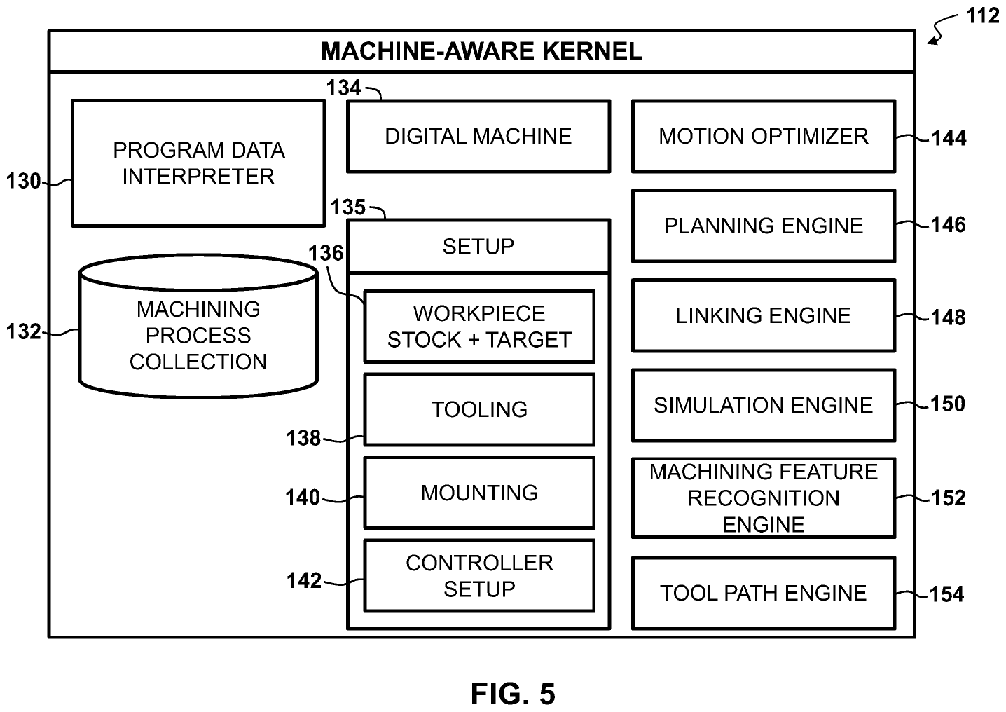

With respect to FIG. 5, the virtual machine-aware kernel 112 may include a program data interpreter 130 for reading and interpreting program data. Program data may be fed to the virtual machine-aware kernel 112 with different formats. In one embodiment, the virtual machine-aware kernel 112 may read and interpret numerical control (NC) code, which may be a series of instructions to be executed sequentially. In another embodiment, the virtual machine-aware kernel 112 may read and interpret machine axis positions or controller instructions, such as low-level instructions describing axis motions and changes of states. In another embodiment, the virtual machine-aware kernel 112 may read and interpret high-level program data, such as Step NC, APT or another high-level format that provides more information on the intentions behind the machining processes. Accordingly, the virtual machine-aware kernel 112, via the program data interpreter 130, may accept as input a number of differently formatted program data. The virtual machine-aware kernel 112 may also include machining process collection component 132, a digital machine component 134, and a setup component 135. More specifically, a user or client may provide setup data. The setup data received at the setup component 135 may include physical and geometrical definitions of workpiece stocks and targets 136, physical and geometrical definitions of all tooling used by the program, such as tooling element 138, and geometric and kinematic definition of the fixtures holding the workpieces, such as mounting 140. In one embodiment, if the user or client includes a setup editor, the virtual machine-aware kernel 112 may further change the program and adapt to the new setup with controller setup 142.

The virtual machine-aware kernel 112 may further include a motion optimizer 144. At any time during the simulation of a cutting process, the virtual machine-aware kernel 112 may determine the engagement of a tool and the volume of material being removed. This information may be used by the motion optimizer 144 to optimize the motion, thus changing the feedrate to prevent overloading the tool. The virtual machine-aware kernel 112 may also know about the physical axes speeds and accelerations resulting from the programmed feedrate. The motion optimizer 144 may modify the programmed feedrate to smooth the motion of the physical axes. The virtual machine-aware kernel 112 may still further include a planning engine 146, a linking engine 148, a simulation engine 150, a machine feature recognition engine 152, and a toolpath engine 154.

The planning engine 146 may modify the order of the machining processes to minimize the overall cycle time. The optimization may look at minimizing the occurrences of changing the cutting tools, minimizing the number of axis rotations, minimizing the total angle of rotation per axis and minimizing the distance of travel of the cutting tools.

In another embodiment, the setup information may be modified outside of the machine-aware kernel and new setup data is input to the machine-aware kernel 112. The planning engine 146 may reorganize and re-optimize the program for the new setup data. A change of setup may be mounting of additional workpieces to increase production, change of fixturing, and/or merging of programs to combine several machining processes into the same job.

The linking engine 148 is configured to execute or perform connecting the machining processes with a trajectory adapted to the machine kinematics and capabilities. The linking engine computes new motions after reordering the machining processes. The linking engine may compute and determine new motions that are compatible with the machine, safe for the setup, and that may lead to faster execution time compared to a scenario where such modifications were not made.

If the original program contains motions that are a problem for the machine, for example, based on the capabilities of the machine, the linking engine 148 may replace such problematic motions by a new safe and optimized path. Possible problems may also include collision with the machine, tool violating the target part, overtravel motions, motions not respecting the kinematics, and/or performing motions that go beyond the capabilities of the machine.

The simulation engine 150 may virtually animate the machine to visualize the program as it happens on the physical machine. The simulation engine 150 may also monitor the machine state along the program to detect exceptions and issues, for example, collision, part violation, and/or impossible motions. The simulation engine may provide feedback to the end-user of the machine with real time animation or with off-line simulation.

The simulation engine 150 may be used as a service by the other engines of the machine-aware kernel. That is, the simulation engine 150 may be used to predict, evaluate, and/or validate machine calculated paths. For instance, in one embodiment, the linking engine evaluates and validates multiple paths to find the most optimized linking paths. The motion optimizer 144 may then use the simulation engine 150 to verify that the calculated motions are valid for the machine. The planning engine 146 may use the simulation engine to evaluate the cycle times.

The machining feature recognition engine 152 may perform an analysis of the part model and recognizes machining features and categorizes the features: Hole, pocket, boss, wall, etc. Each feature is further described by machining information. For instance, a hole may be further described as a tapped hole or a countersink hole. The toolpath engine 154 may calculate a geometric toolpath to cut a machining feature.

As described above, the disclosed embodiments of the virtual machine-aware kernel 112 may determine and predict steps for the manufacturing of a virtual machine part based on simulations performed on an accurate digital representation of the CNC machine 102. The virtual machine-aware kernel 112 may then execute these steps on the CNC machine 102, thus running a virtual model on the real-world CNC machine 102. In this way, the virtual machine-aware kernel 112 is the engine that provides for changing and updating, in real time, the steps, and hence, the machining program configured to determine a machining process for the CNC machine 102.

Real-world situations may be encountered by the virtual machine-aware kernel 112 that have not been simulated, thus requiring modification of the predictive virtual engine. Therefore, it is desired to have the virtual machine-aware kernel 112 retrieve as much data as possible in order to optimize the data to make adjustments in real-time and dynamically make changes as necessary while the machining program is being executed.

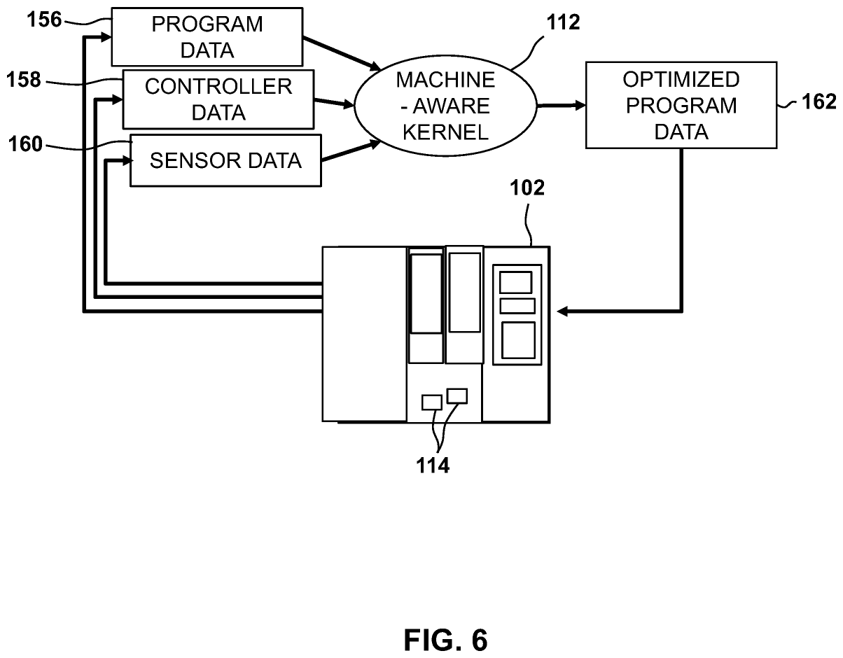

With respect to FIG. 6, the virtual machine-aware kernel 112 is depicted as receiving data from the CNC machine 102. In one embodiment, the virtual machine-aware kernel 112 receives programming data 156. In one embodiment, the machine-aware kernel 112 may be used off-line to optimize the received program data 156. As described above, the program data 156 may be fed to the virtual machine-aware kernel 112 with different formats. For example, the virtual machine-aware kernel 112 may read and interpret numerical control (NC) code data, which may be a series of instructions to be executed sequentially. The virtual machine-aware kernel 112 may also receive controller data 158 such as tool offset information, work offset information or machine controller configuration. Finally, the virtual machine-aware kernel 112 may receive sensor data 160 associated with sensors 114 of the CNC machine 102. The virtual machine-aware kernel 112 may use the data as inputs to continually make the virtual machine-aware kernel 112 more efficient and capable of making predictive decisions based on real-time data from CNC machine sensors 114. The machine-aware kernel 112 may collect the program data 156, controller data 158, and sensor data 160 to manage the data and dynamically update the machining program in real time with optimized program data 162.

In one embodiment, the sensors 114 may detect what is occurring during the machining process in real-time. For example, machining (i.e., milling) of a tool may include a sequence of evermore precise and refined cuts. The sensors 114 may detect a cutting speed of a machining tool and the virtual machine-aware kernel 112 receives the data from the sensors 114, such as the cutting speed. For example, the virtual machine-aware kernel 112 may detect that cutting speed is too fast or too slow at any given step as compared to what was predicted by the virtual machine-aware kernel 112 in the virtual model. The virtual machine-aware kernel 112 then manages the CNC machine 102 by reinterpreting and optimizing the data received from the sensors 114 (as well as the program data 156 and the controller data 158) in order to update the machining program in real-time to adjust the cutting speed to be at a cutting speed that makes the milling process more precise. More specifically, the virtual machine-aware kernel 112 updates the subsequent steps in the program (not only the next step, but several steps down the line), making the milling more and more precise. Thus, the sensors 114 detect what is happening in the CNC machine 102 and the virtual machine-aware kernel 112 adjusts the virtual model in real-time based on the data received from the sensors 114. Therefore, the virtual machine-aware kernel 112 may continually become more capable of predicting future steps for accurate production of discrete machine parts.

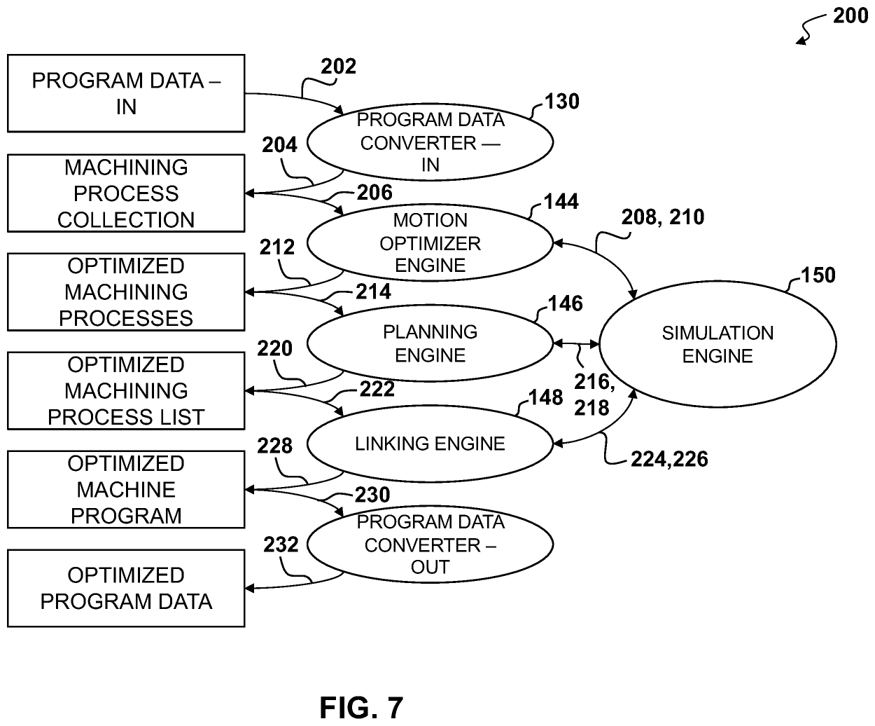

FIG. 7 depicts the data flow and sequence of events and steps of the virtual machine-aware kernel. Embodiments may include a method 200 of managing and optimizing a machining process for a CNC machine tool with the virtual machine-aware kernel 112. The data flow sequence of virtual machine-aware kernel 112 may comprise the following steps, and not necessarily in this order: (a) program data, such as NC code data, which may be a series of instructions to be executed sequentially, may be received at the program data converter 130 for reading and interpreting the program data 202; (b) the program data converter 130 is then received at a machining process collection 204 for recognizing different actions of the program and organizing the program into sequences of machining processes (e.g., a group of machine instructions); (c) the program 206 is then sent from the machining process collection 204 to the motion optimizer 144 for optimizing the motion; (d) the motion optimizer 144 may then send the motion optimized program 208 to the simulation engine 150 for verification and validation of the program; (e) the simulation engine 150, in turn, may send the verified program 210 back to the motion optimizer 144; (f) the motion optimizer 144 then determines and generates optimized machining processes 212 based on the successful verification by the simulation engine 150; (g) the planning engine 146 may then receive the optimized machining processes 212 for sequencing of the program 214; (h) the planning engine 146 then sends the sequenced program 216 to the simulation engine 150 for verification and validation; (i) the simulation engine 150 may return the verified sequenced program 218 to the planning engine 146; (j) the planning engine 146 then determines and generates the optimized machining process list 220 based on the successful verification by the simulation engine 150; (k) the optimized machining process list 220 is then passed to the linking engine 148 to link all of the sequences of the program, connecting the machining processes with a trajectory adapted to the machine kinematics and capabilities. The linking engine 148 determines and computes new motions after reordering the machining processes 222; (1) the linking engine 148 sends the program 224 to the simulation engine 150 for verification and validation; (m) the simulation engine 150 returns the verified program 226 back to the linking engine 146; (n) the linking engine 146 determines and generates an optimized machine program 228 for construction of the final program; (o) the optimized machine program sends the final program 230 to the program data converter for output; (p) the program data converter outputs the final program as optimized program data 232, such as NC code or machine code instructions.

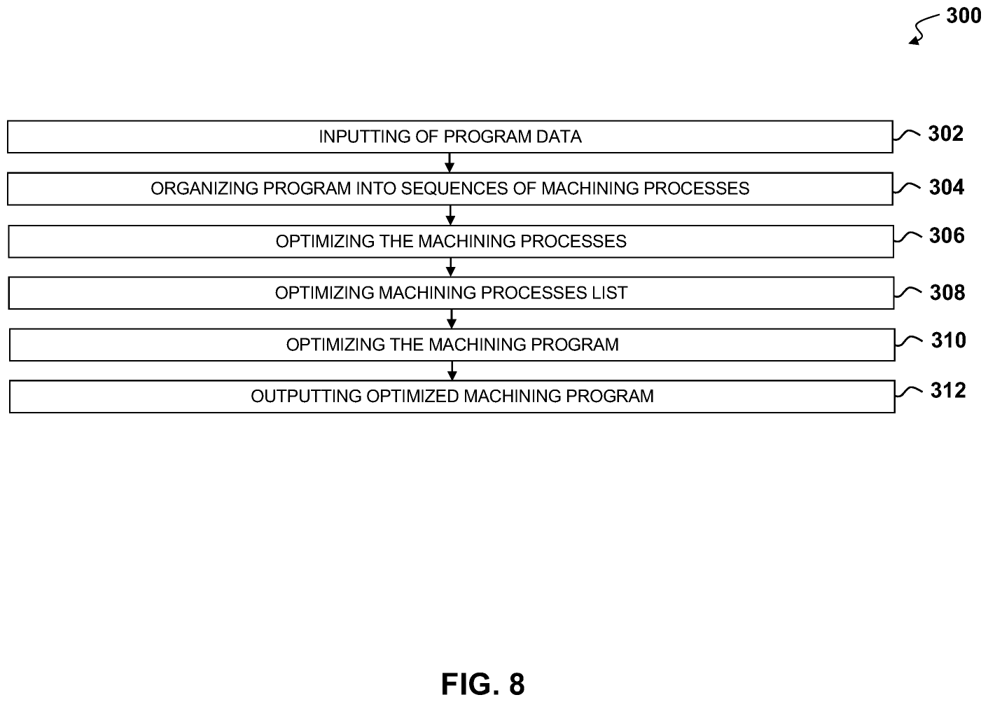

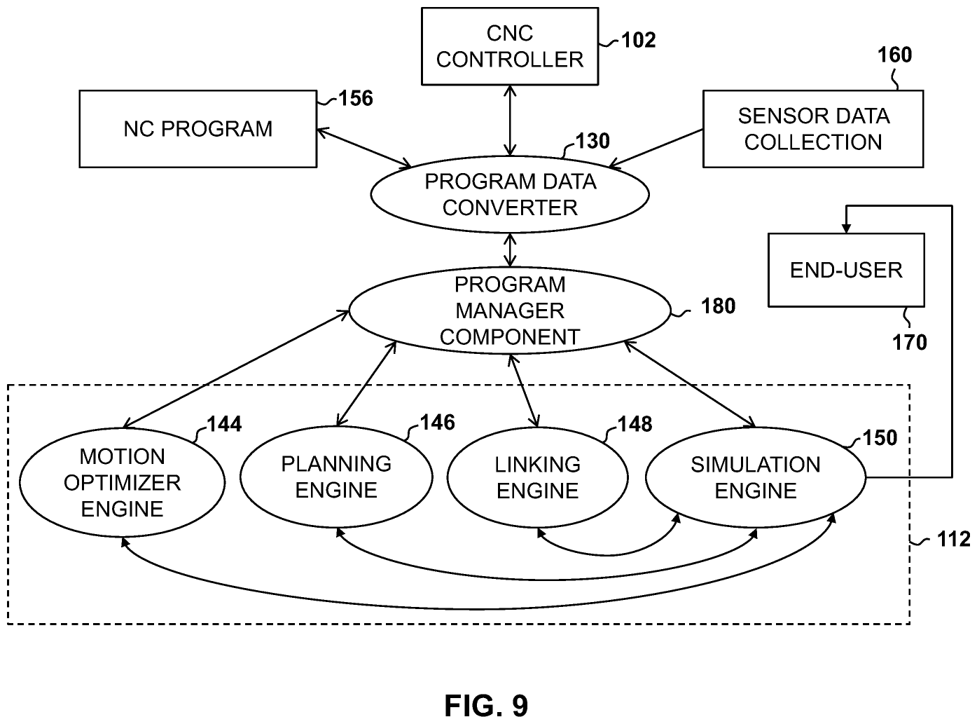

FIG. 8 illustrates in a top-level flowchart, where a method 300 for managing and optimizing a machining process for a CNC machine tool with a program manager component 180 (see FIG. 9) of the virtual machine-aware kernel 112 (see FIGS. 5-6, 9) is shown. At step 302, program data, such as NC code data, which may be a series of instructions to be executed, is received as input to the program manager component 180 of the virtual machine-aware kernel 112. The virtual machine-aware kernel may then organize the program into a sequence or sequences of machining processes, for example, according to process precedence criteria to generate the final order of machining operations, as shown at step 304. The virtual machine-aware kernel may then optimize the machining process at step 306, based on the received updated program from the motion optimizer 144 (see FIG. 7). In further detail, in one embodiment, the motion optimizer 144 may change the feedrate to prevent overloading the tool. The virtual machine-aware kernel 112 may also determine the optimized machining process based on the physical axes speeds and accelerations resulting from the programmed feedrate. In one example, the motion optimizer 144 may update, e.g., modify, the programmed feedrate to smooth the motion of the physical axes. The virtual machine-aware kernel may then update the program based on the received program from the motion optimizer 144. Continuing to the next step, at step 308, a machining process list is optimized by the virtual machine-aware kernel, based on receiving the program from the planning engine 146 (see FIG. 7). The linking engine 148 (see FIG. 7) may then link the optimized process list and, at step 310, the virtual machine-aware kernel may optimize the machining program based on the optimized machining processes and the optimized machining processes list. Finally, at step 312, the virtual machine-aware kernel may output the optimized machining program to an end-user or CNC controller.

With respect to FIG. 9, a functional block diagram for managing and optimizing a machining process for a CNC machine tool with the virtual machine-aware kernel 112 is depicted. In one embodiment, the program data converter 130 and program manager component 180 may be part of the virtual machine-aware kernel 112. In another embodiment, the program data converter 130 and program manager component 180 may be external components to the virtual machine-aware kernel 112. In yet another embodiment, the program data converter 130 may be an external component while the program manager component 180 may be part of the virtual machine-aware kernel 112. For simplicity, FIG. 9 depicts the program data converter 130 and program manager component 180 as external components to the virtual machine-aware kernel 112 but one skilled in the art would appreciate that any combination as described above may be implemented.

In one embodiment, Numerical Control (NC) program 156 may be interpreted by the program data converter 130 and converted to program data collection by the program manager component 180 for the virtual machine-aware kernel 112. After processing, the virtual machine-aware kernel 112 may return an optimized program, or NC code, such as direct instructions to a CNC controller 102 or the CAM system. In another embodiment, the CNC machine controller 102 may directly provide program data to the virtual machine-aware kernel 112 (not shown in FIG. 9). The virtual machine-aware kernel 112, in turn, may provide to the machine, optimized controller instructions.

In one embodiment, the CNC machine 102 may be equipped with sensors 114, and sensor data may be sent to a sensor data collection 160 component. The sensors 114 may be used to monitor tool condition in machining process by, for example, measuring the cutting force (with a multi-channel table dynamometer or rotating dynamometer); vibration amplitude using multi-channel accelerometers; audible sound from the machining process; high-frequency sound or acoustic emission. In other embodiments, sensor-less machine tool monitoring may be performed by measuring internal drive signals such as: feed motor current, spindle motor current, spindle power. In yet other embodiments, a combination of the sensor and sensor-less measuring and monitoring may be implemented. The sensor data may then be passed to the program data converter 130 for enhanced optimization.

In further detail, in one embodiment, the simulation engine 150 may determine a virtual animation of the CNC machine to visualize the program data as it is executed on the physical CNC machine in real time. The simulation engine 150 may monitor the CNC machine state to detect potential issues, such as collision, part violation, impossible motions, and the like. The simulation engine 150 may provide feedback to an end-user 170 of the CNC machine with real-time animation or with an off-line simulation.

The motion optimizer engine 144, the planning engine 146 and the linking engine 148 communicate with the simulation engine 150 to evaluate alternative solutions and to validate solutions. For example, the motion optimizer engine 144 optimizes the motions, such as changing the feedrate to prevent overloading the tool. The motion optimizer 144 may also modify the programmed feedrate to smooth the motion of the physical axes. The planning engine 146 may modify the order of the machining processes to minimize the overall cycle time. The optimization may look at a number of factors, for example: minimizing the occurrences of changing the cutting tools, minimizing the number of axis rotations, minimizing the total angle of rotation per axis and/or minimizing the distance of travel of the cutting tools. The planning engine 146 may then communicate the optimized ordering to the simulation engine 150 for verification and evaluation of cycle times.

The linking engine 148, in turn may connect the machining processes with a trajectory adapted to the machine kinematics and capabilities. The linking engine 148 computes new motions after reordering the machining processes. The linking engine 148, based on the received data from the planning engine 146, communicates the most optimized path to the simulation engine 150, which evaluates and verifies the most optimized path. In one embodiment, if the original program contains motions that pose a problem for the CNC machine 102 to execute, the linking engine 148 may recalculate and replace the motions with a new optimized path in order to avoid such problems that may occur during execution by the CNC machine 102. Some examples of possible problems that may occur during execution by the CNC machine 102 may include: collisions within the machine, tool violating the target part, over-travel motions, and/or motions not respecting the kinematics and the capabilities of the machine.

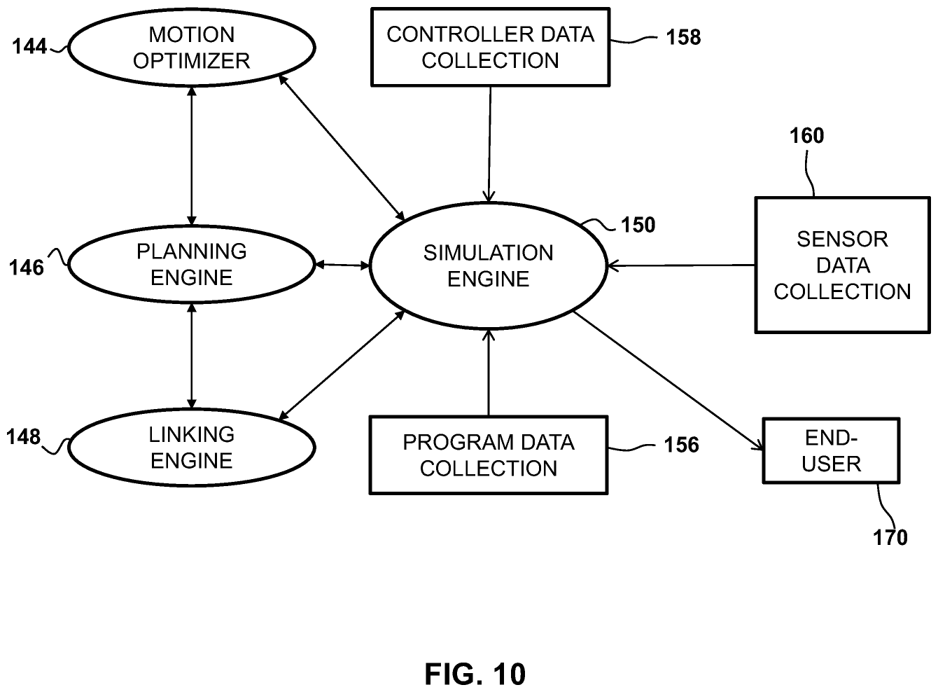

FIG. 10 illustrates another functional block diagram of the management and optimization by the virtual machine-aware kernel, for a CNC machine tool. In one embodiment, the simulation engine 150 may receive program data, such as NC code, from a program data collection 156 component. The simulation engine 150 may determine a virtual animation of the machine, using the received program data, to visualize the program data as is executed on the physical CNC machine. The simulation engine 150 may monitor the CNC machine state via a controller data collection 158 component to detect potential issues, as described above, via, for example, received real-time data from the sensors 114 (see FIG. 6). In one embodiment, the sensor data may be collected by a sensor data collection 160 component which may be dedicated to routing sensor data reading from the CNC machine. The simulation engine 150 may communicate the received sensor data to the motion optimizer 144, the planning engine 146, and the linking engine 148 for further processing. In one embodiment, the simulation engine 150 may provide feedback to an end-user 170 of the CNC machine with real-time animation or with off-line simulation.

In one embodiment, the sensor data may be used by the motion optimizer 144 to, for example, optimize the motion, thus changing the feedrate to prevent overloading the tool. The motion optimizer 144 may also modify the programmed feedrate to smooth the motion of the physical axes. The motion optimizer 144 may use the simulation engine 150 to verify that the calculated optimized motion is correct, and, in turn, communicate the optimized federate back to the simulation engine 150. The planning engine 146 may receive as input, the sensor data from the simulation engine 150 to modify the order of the machining processes and for example, to minimize the overall cycle time. The optimization may be determined based on a number of factors, for example: minimizing the occurrences of changing the cutting tools, minimizing the number of axis rotations, minimizing the total angle of rotation per axis and/or minimizing the distance of travel of the cutting tools, etc. The planning engine 146 may then communicate the optimized ordering to the simulation engine 150 for verification and evaluation of cycle times.

In another embodiment, the planning engine 146 may communicate the ordering to the linking engine 148 to evaluate and optimize cycle times. The linking engine 148, in turn may connect the machining processes with a trajectory adapted to the machine kinematics and capabilities. The linking engine 148 may then compute and determine new motions after reordering the machining processes. The linking engine 148, based on the received data from the planning engine 146, may communicate the most optimized path to the simulation engine 150, which evaluates and verifies the most optimized path. In one embodiment, the simulation engine 150 may dynamically, and in real-time, update the program data received initially from the program data interpreter 130. In one embodiment, the simulation engine 150 may perform this task based on received sensor data from the sensor data collection component 172, linking engine component 148, planning engine component 146, and motion optimizer component 144 as depicted. Accordingly, based on the input data received from the aforementioned components, the simulation engine 150 may continuously optimize the machine processes while the CNC machine is performing associated functions.

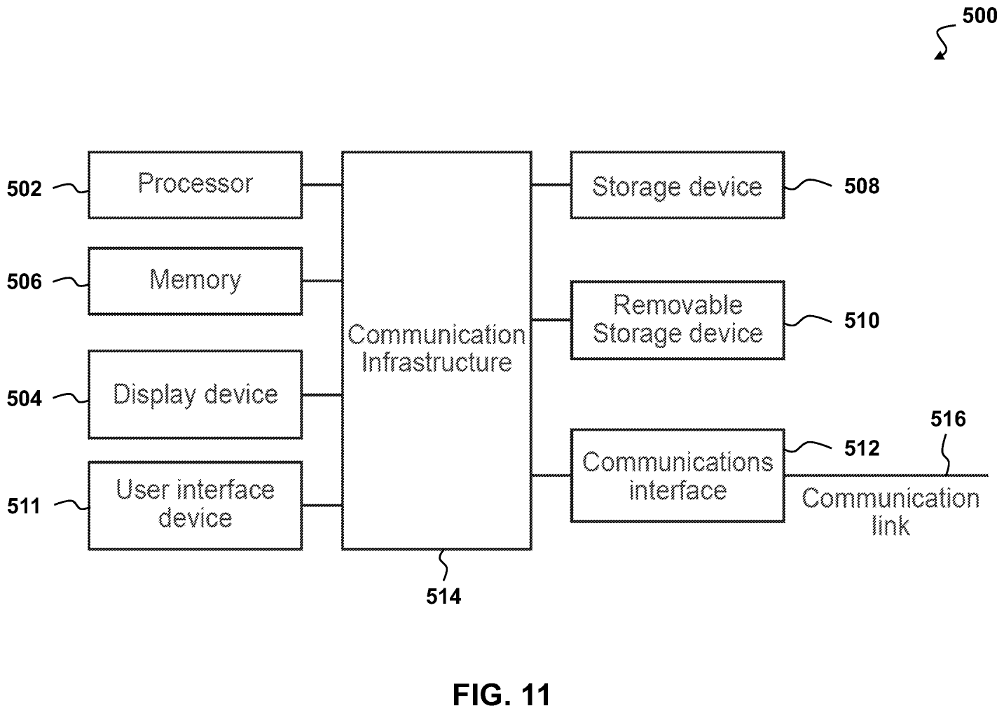

FIG. 11 is a high-level block diagram 500 showing a computing system comprising a computer system useful for implementing an embodiment of the system and process, disclosed herein. Embodiments of the system may be implemented in different computing environments. The computer system includes one or more processors 502, and may further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, may be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

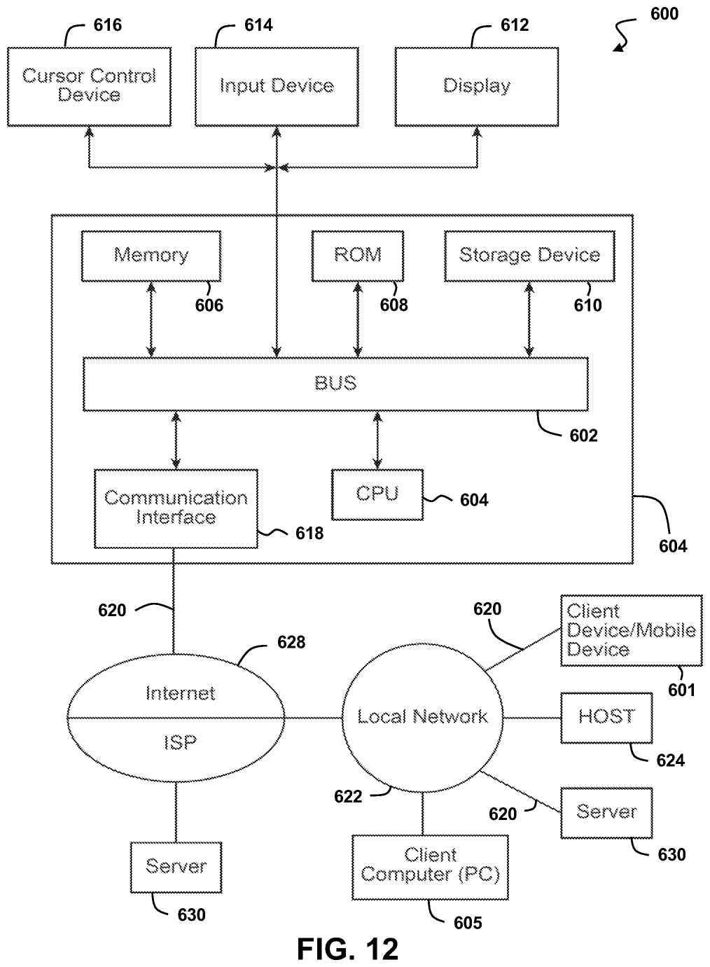

FIG. 12 shows a block diagram of an example system 600 in which an embodiment may be implemented. The system 600 includes one or more client devices 601 connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 may also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media may also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer may read.

Various forms of computer readable media may be involved in carrying one or more sequences of one or more instructions to the processor 604 for execution. For example, the instructions may initially be carried on a magnetic disk of a remote computer. The remote computer may load the instructions into its dynamic memory and send the instructions over a telephone line using a modem. A modem local to the server 630 may receive the data on the telephone line and use an infrared transmitter to convert the data to an infrared signal. An infrared detector coupled to the bus 602 may receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which may comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 may send/receive messages and data, including e-mail, program code, through the network, the network link 620 and the communication interface 618. Further, the communication interface 618 may comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and may depend on performance of the system 600 implementing the embodiments. As such, the logical operations constituting said example versions of the embodiments are referred to for e.g., as operations, steps or modules.

Similar to a server 630 described above, a client device 601 may include a processor, memory, storage device, display, input device and communication interface (e.g., e-mail interface) for connecting the client device to the Internet 628, the ISP, or LAN 622, for communication with the servers 630.

The system 600 may further include computers (e.g., personal computers, computing nodes) 605 operating in the same manner as client devices 601, where a user may utilize one or more computers 605 to manage data in the server 630.

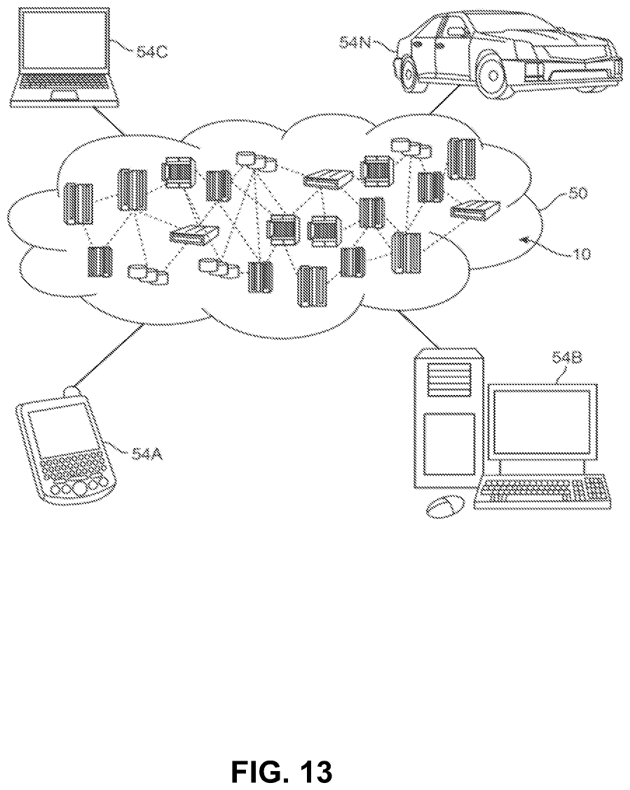

Referring now to FIG. 13, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 10 and cloud computing environment 50 may communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a computer numerical control (CNC) machine having machining tools and configured to execute a series of instructions for machine operation;
a computing device in communication with the CNC machine, wherein the computing device having a processor and an addressable memory, is configured to execute a virtual machine-aware kernel processor-executable set of instructions to:
determine, via a simulation engine, a virtually simulated real-world CNC machine and associated potential malfunctions based on received data from the CNC machine, the received data comprising program data, controller data, and sensor data;
determine, in real-time and while a machining program is being executed by the CNC machine, a modification to the machining program based on the determined virtually simulated real-world CNC machine and associated potential malfunctions, wherein the modification is based on determination of optimized program data that avoids the associated potential malfunctions; and
transmit the determined optimized program data associated with the machine operation to the CNC machine, thereby the CNC machine continues with production and does not stop manufacturing process.

2. The system of claim 1, wherein the computing device, via the virtual machine-aware kernel, is further configured to modify the CNC machining program in real-time thereby predicting potential manufacturing issues and optimizing the data provided in the machining program by updating one or more subsequent steps in the machining program.

3. The system of claim 2, wherein the determined optimized program data associated with the machine operation provides precise milling operations by predicting future steps for accurate production of discrete machine parts.

4. The system of claim 1, wherein the program data is a series of instructions to be executed sequentially, providing a machining program to the CNC machine.

5. The system of claim 1, wherein the controller data comprises CNC controller related data, comprising at least one of: tool offset information, work offset information, and machine controller configuration.

6. The system of claim 1, wherein sensor data is data associated with one or more sensors of the CNC machine and wherein the one or more sensors detect what is occurring during the machining process in real-time.

7. The system of claim 6, wherein the one or more sensors of the CNC machine are configured to monitor the machine tool by measuring at least one of: the cutting force, vibration amplitude, audible sound from the machining process, and high-frequency sound.

8. The system of claim 1, wherein modification to the machining program is based on prediction of the potential malfunction, determined using virtual data generated from the virtually simulated real-world CNC machine.

9. The system of claim 8, wherein the potential malfunctions is execution of CNC machining program that results in damage to the CNC machine, comprising at least one of: a tool colliding with a workpiece or with equipment holding the workpiece, damage to a tool due to too much engagement into material, resulting in tool breakage, violation of a target part due a tool cutting too much and gouging into a target part, slow execution where the machine cannot move fast enough because the instructions are not adapted to the machine kinematics, bad surface finish caused by vibrations due to bad cutting conditions or lack of rigidity.

10. The system of claim 1, wherein the simulation engine of the virtual machine-aware kernel is in communication with a motion optimizer engine, a planning engine, and a linking engine.

11. A method comprising:
determining, by a simulation engine of a virtual machine-aware kernel, a virtually simulated real-world computer numerical control (CNC) machine and associated potential malfunctions based on received data from the CNC machine, the received data comprising program data, controller data, and sensor data;
determining, in real-time and while a machining program is being executed by the CNC machine, a modification to the machining program based on the determined virtually simulated real-world CNC machine and associated potential malfunctions, wherein the modification is based on determination of optimized program data that avoids the associated potential malfunctions; and
transmitting the determined optimized program data associated with the machine operation to the CNC machine, thereby the CNC machine continues with production and does not stop manufacturing process.

12. The method of claim 11, wherein the simulation engine of the virtual machine-aware kernel is in communication with a motion optimizer engine, a planning engine, and a linking engine.

13. The method of claim 12, wherein the motion optimizer of the virtual machine-aware kernel is configured to modify tool motion, thus preventing overloading a machine tool and smoothing the tool motion on the physical axes.

14. The method of claim 13, wherein the motion optimizer of the virtual machine-aware kernel is configured to calculate optimized motion via modifying machine tool motion, thus preventing overloading a machine tool and smoothing the tool motion on the physical axes.

15. The method of claim 14, wherein the motion optimizer of the virtual machine-aware kernel is configured to verify that the calculated optimized motion is correct by running the calculated optimized motion through the virtually simulated real-world CNC machine.

16. The method of claim 15, wherein the planning engine of the virtual machine-aware kernel is configured to determine an optimized ordering by modifying the order of the machining processes based on the received sensor data, wherein the modification is based on at least one of: minimizing occurrences of changing cutting tools, minimizing number of axis rotations, minimizing total angle of rotation per axis, and minimizing distance of travel of cutting tools.

17. The method of claim 16, wherein the planning engine of the virtual machine-aware kernel is configured to communicate the determined optimized ordering to the simulation engine for verification and evaluation of cycle times.

18. The method of claim 16, wherein the planning engine of the virtual machine-aware kernel is configured to communicate the determined optimized ordering to the linking engine for verification and evaluation of cycle times.

19. The method of claim 18, wherein the linking engine of the virtual machine-aware kernel is configured to connect machining processes with a trajectory adapted to machine kinematics and capabilities associated with the CNC machine, and determine new motions after reordering the machining processes; the linking engine is further configured to, based on the received data from the planning engine, communicate the determined new motions comprising optimized path, to the simulation engine.

20. The method of claim 19, wherein the simulation engine is configured to, continuously and in real-time, update the program data received initially from a program data interpreter to optimize the machine processes while the CNC machine is performing associated functions.
